(19) United States
(12) Patent Application Publication
(10) Pub. No.: US 2019/0153722 A1
(43) Pub. Date: May 23, 2019

(54) Insulation Material Arrangement

(71) Applicant: Schmetzer Industries Holdings Pty Limited, Hornsby NSW (AU)

(72) Inventors: Brett Anthony Schmetzer, Hornsby (AU); Steven John Schmetzer, Hornsby (AU)

(21) Appl. No.: 16/097,504

(22) PCT Filed: Apr. 21, 2017
(86) PCT No.: PCT/AU2017/050365

§ 371 Date: Oct. 29, 2018

(30) Foreign Application Priority Data
Apr. 29, 2016 (AU) 2016901576
Apr. 29, 2016 (AU) 2016901577
Oct. 20, 2016 (AU) PCT/AU2016/050983

(51) Int. Cl. E04B 1/80; E04B 1/94; E04B 1/76; B32B 5/18; B32B 7/06; B32B 7/12; B32B 25/06; B32B 5/02; B32B 5/26; B32B 25/08; B32B 25/20; C09J 7/38; C09J 7/50; C09J 7/21; C09J 7/40; C09J 11/04; C09J 5/00; C09J 11/08; C09K 21/14; C09K 5/06; F28D 20/02

(52) U.S. Cl. CPC E04B 1/80; E04B 2001/742; E04B 1/7675; B32B 5/18; B32B 7/06; B32B 7/12; B32B 25/06; B32B 5/02; B32B 5/26; B32B 25/08; B32B 25/20; C09J 7/38; C09J 7/50; C09J 7/21; C09J 7/405; C09J 11/04; C09J 5/00; C09J 11/08; C09K 21/14; C09K 5/063; F28D 20/023; E04B 1/948

(57) ABSTRACT

An insulating material arrangement (10) is disclosed for insulating a building structure (50) such as a wall (52). The material arrangement (10) includes a planar backing layer (12), a planar adhesive layer (14) co-planar with the backing layer (12) and a planar phase change material (“PCM”) layer (16) which is arranged between the backing layer (12) and the adhesive layer (14), and is also co-planar therewith. The adhesive layer (14) is adapted to secure the material arrangement (10) to the structure in a fitted condition in which the adhesive layer (14) is contacted with the building structure (50). The PCM layer (16) is formed of a silicone foam polymer that is impregnated in some embodiments with micro-encapsulated phase change material in the form of beads, shells or granules (110), and in another arrangement, the PCM layer can also comprise a silicone foam polymer that is impregnated with a phase change material which is absorbed into an amount of porous, inorganic, finely-sized particulate solids (a so-called “bound PCM”).

### TECHNICAL FIELD

This disclosure relates to an insulation material arrangement, in particular, such as arrangement including a phase change material.

### BACKGROUND OF THE DISCLOSURE

Insulation is desirable, and often required, to be placed in building structures such as insulating a wall, roof or ceiling. Accordingly, various types of insulation materials have been proposed including those that include phase change materials.

Phase change materials are materials that change phase to absorb or release heat, causing a change in the “state” or “base” of the materials. For example, in one type of these, the phase change materials are transformed between a solid and a liquid form. Generally, the heat applied to a phase change material is “consumed” by the material during its conversion from solid state to liquid state while the phase change material maintains a substantially constant temperature. In reverse, the heat that was absorbed by the change to the liquid phase is released when the phase change material gives up its latent heat of liquidation and reverts into its solid state. Accordingly, the incorporation of phase change materials allows insulation material to better insulate building structures.

One such insulation material is disclosed in U.S. Pat. No. 5,626,936 that discloses a thermal insulation system suitable for placement in a ceiling or wall structure of a building or dwelling, and the system includes phase change material (“PCM”) usually sandwiched as an intermediate layer between two other layers of insulative material. The disclosed PCM material is disclosed as being phase change material is selected from the group consisting essentially of: calcium chloride hexahydrate, sodium sulfate, paraffin, Na₂SO₄.10H₂O, CaCl₂.6H₂O, NaHPO₄.12H₂O, Na₂S₂O₃.5H₂O and NaCO₃.10H₂O. The disclosed PCM is heated above its phase change state to being a liquid state in which it is applied, as a heated liquid, to the two other layers of insulative material. In use, the complete insulation material is then placed against building structures such as a ceiling or a wall.

A problem with this insulation material relates to ease and speed of use and, in particular, the ease and speed of application of this insulation material to surfaces within a building such as vertical walls, the underside of surfaces or wrapping around corners.

Another problem with this insulation material is that it may be difficult and/or costly to manufacture as it requires heating to liquefy the PCM before applying the PCM to the insulation sheets. The heating may also limit the materials that may be applied to the PCM during manufacture, require additional waiting time or the heating may damage or limited the types of the PCM used. Yet another problem with this insulation material is that the material may need to be relatively thick to achieve desirable the insulative properties.

Another problem encountered when dealing with phase change materials is their flammability. PCM can contain hydrocarbon substances, for example paraffin. There are concerns about leakage, volume expansion, and/or flammability associated with the use of hydrocarbon PCMs.

### SUMMARY

In a first aspect of the present disclosure, embodiments are provided of a material arrangement for insulating a building structure, the material arrangement including: a backing layer; an adhesive layer including a pressure sensitive adhesive; and a phase change material layer between the backing layer and the adhesive layer; wherein the phase change material layer includes a fire-retardant silicone foam polymer material which is impregnated with phase change material, and the adhesive layer is adapted to secure the material arrangement to the structure in a fitted condition in which the adhesive layer is contacted with the building structure.

In the present specification, the term “fire-retardant” or “flame-retardant” is given to mean a material that resists burning, or if it does eventually burn, it does so slowly.

In some embodiments, the material arrangement further includes a removable layer arranged to cover the adhesive layer in an initial covered condition and expose the adhesive layer in a removed condition. In one form of this, at least one of the backing layer and removable layer is paper.

In some embodiments, the material arrangement is flexible so as to be formable into a roll.

In some embodiments, the phase change material layer includes a liquid-solid phase change material.

In some embodiments, the phase change material layer includes an encapsulated phase change material. In one embodiment, the encapsulated phase change material is a micro-encapsulated phase change material. In one form of this, the micro-encapsulated phase change material is provided in the form of a least one of beads and granules.

In some alternative embodiments, the phase change material layer includes a phase change material disposed in a porous support structure. In one embodiment, the phase change material is bound or absorbed into the porous support structure. In one form of this, the porous support structure is an inorganic particulate material. In a particular form of this, the inorganic particulate material is a silicon dioxide (silica) powder.

In some embodiments, the silicone foam polymer material is a polysiloxane polymer.

In some embodiments, the pressure sensitive adhesive includes an elastomer compounded with a suitable tackifier.

In some embodiments, the material arrangement according to any one of the preceding claims, wherein the backing layer may be at least one of paper, polymeric film, foil, nonwoven or high thread count woven cloth, and wherein the adhesive layer includes an acrylic, rubber or silicone adapted to be tacky at ambient temperature.

In a second aspect of the present disclosure, embodiments are provided of a self-adhering material arrangement including a flexible phase change material layer and a pressure sensitive adhesive layer applied to a face of the phase change material layer, wherein the phase change material layer includes a fire-retardant silicone foam polymer material impregnated with phase change material, and wherein the adhesive layer is adapted to adhere the phase change material layer to a supporting surface in a fitted condition in which the adhesive layer is urged against the supporting surface.

In some embodiments, the phase change material layer of the second aspect is otherwise as defined in the first aspect.

In some embodiments, the pressure sensitive adhesive of the second aspect is otherwise as defined in the first aspect.

In a third aspect of the present disclosure, embodiments are provided of a method of forming a self-adhering material arrangement, the method including the steps of: forming a flexible phase change material layer supported by a backing, the phase change material layer including a fire-retardant silicone foam polymer material impregnated with phase change material; and applying a pressure sensitive adhesive layer to a face of the phase change material layer, the adhesive layer being adapted to secure the material arrangement to a building structure or material in a fitted condition in which the adhesive layer is pressed against the structure or material.

In some embodiments, the steps for forming the flexible phase change material layer further include: providing, a liquid mixture that is cold curable to provide the flexible silicone foam polymer; introducing, a phase change material into the liquid mixture so that it is substantially dispersed throughout; and curing, the liquid mixture so as to form the flexible phase change material layer upon which the adhesive layer is applied.

In some embodiments, the phase change material layer of the third aspect is otherwise as defined in the first aspect.

In some embodiments, the pressure sensitive adhesive of the third aspect is otherwise as defined in the first aspect.

In a fourth aspect of the present disclosure, embodiments are provided of a method of applying an insulation material to a building structure, the method including the steps of: urging a pressure sensitive adhesive layer of a material arrangement against a surface of the building structure such that a phase change material layer of the material arrangement is bonded to the surface, wherein the phase change material layer includes a fire-retardant silicone foam polymer material impregnated with phase change material, and a backing layer that supports the phase change material layer is facing away from the surface.

In some embodiments, the method further includes the step of removing a cover layer from the adhesive layer.

In some embodiments, the phase change material layer of the fourth aspect is otherwise as defined in the first aspect.

In some embodiments, the pressure sensitive adhesive of the fourth aspect is otherwise as defined in the first aspect.

In a fifth main aspect of the present disclosure, embodiments are provided of, a material arrangement for insulating a building product, the material arrangement including a backing layer, an adhesive layer including a pressure sensitive adhesive, and a phase change material layer between the backing layer and the adhesive layer, wherein the phase change material layer includes a fire-retardant silicone foam polymer material which is impregnated with phase change material, and the adhesive layer is adapted to secure the material arrangement to the building product in a fitted condition in which the adhesive layer is contacted with the building product.

In some embodiments, the phase change material layer of the fifth aspect is otherwise as defined in the first aspect.

In some embodiments, the pressure sensitive adhesive of the fifth aspect is otherwise as defined in the first aspect.

Other aspects, features, and advantages will become further apparent from the following detailed description when read in conjunction with the accompanying drawings which are a part of this disclosure and which illustrate, by way of example, principles of the inventions disclosed.

### DESCRIPTION OF THE FIGURES

The accompanying drawings facilitate an understanding of the various embodiments of an insulation material arrangement:

FIG. 1 is a schematic, perspective view illustrating an embodiment of a material arrangement including a backing layer, and a contact adhesive layer and a phase change material layer;

FIG. 2 is a schematic, perspective view illustrating an embodiment of the material arrangement as shown in FIG. 1, further including a removable cover layer over the contact adhesive layer, an edge of the removable cover being peeled back to reveal the contact adhesive layer;

FIG. 3a is a detailed, side cross-sectional view illustrating the material arrangement as shown in FIG. 2;

FIG. 3b is a detailed, side cross-sectional view of a portion of the material arrangement as shown in FIG. 1, illustrating a bead of an encapsulated phase change material located in a portion of a phase change material layer;

FIG. 4a is a schematic, perspective view illustrating the material arrangement as shown in FIG. 2, illustrating the removable cover layer being partially removed in preparation for fitting the material arrangement onto a wall of a building structure;

FIG. 4b is a schematic, perspective view illustrating a wall of a building structure to which the material arrangement as shown in FIG. 4a has been fitted; and

FIG. 4c is a detailed, side cross-sectional view illustrating a portion of the material arrangement as shown in FIGS. 4a and 4b when affixed to a wall of a building structure.

### DETAILED DESCRIPTION

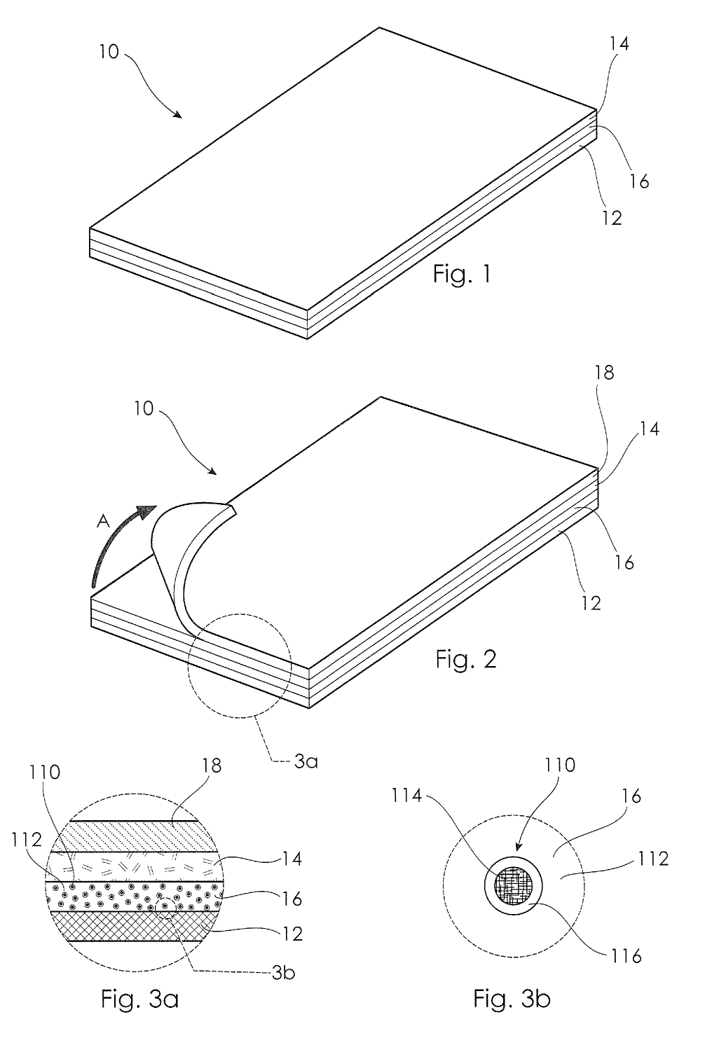

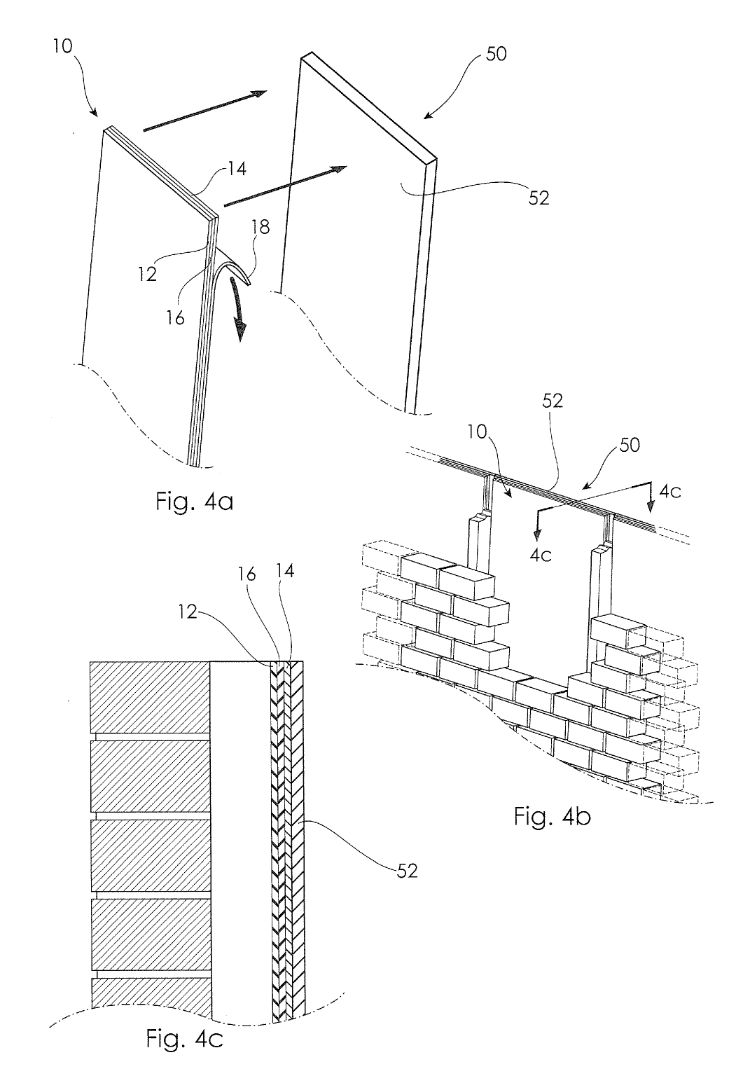

Referring to FIG. 1, there is shown a material arrangement 10 for insulating a building structure 50 such as a wall 52 (shown in FIG. 4b). The material arrangement 10 includes a planar backing layer 12, a planar adhesive layer 14 (co-planar with the backing layer 12) and a planar phase change material (“PCM”) layer 16 which is arranged between the backing layer 12 and the adhesive layer 14, and is also co-planar therewith. The material arrangement 10 shown in FIG. 1 is of exemplary length and width to illustrate the cross-sectional layer arrangement, and can be manufactured as a multi-layer sheet, panel or elongate strip form in any suitable continuous length, having a width which is subject only to the width of the machine used to form the multi-layer material arrangement 10.

The adhesive layer 14 includes a pressure sensitive adhesive adapted to secure the material arrangement 10 to the structure 50 in a fitted condition in which the adhesive layer is contacted with, or pressed against, the building structure or material 50. The building structure or material 50 may be or include a wall, a wall panel such as plasterboard, a roof, a ceiling panel or the like. In other examples, the building structure or material 50 may be a further insulation or cladding material.

The backing layer 12 may be at least one of be paper, polymeric film, foil, nonwoven or high thread count woven cloth, and the adhesive layer 14 may include an acrylic, rubber or silicone adapted to be tacky at ambient temperatures. In some examples, the pressure sensitive adhesive includes an elastomer compounded with a suitable tackifier.

Referring to FIG. 2, in one form the material arrangement 10 also includes a removable layer 18 arranged to cover the outermost face of the adhesive layer 14 in an initial covered condition, and to expose the adhesive layer 14 in a removed condition. The removable layer 18 may be paper or a similar material sheet that may be peeled by hand, to be progressively removed away from the outermost face of the adhesive layer 14.

However, in some examples such as that shown in FIG. 1, the removable layer 18 may be omitted, and the material arrangement 10 may be provided in an initial “rolled-up” form to an end user rolled with the outermost face of the adhesive layer 14 supplied initially pressed up against the outermost face of the backing layer 12. In this form, the material arrangement 10 is supplied as an elongate strip reel when supplied to the end user, and various lengths can then be unrolled and cut to size per the particular requirements. Accordingly, in these examples, the backing layer 12 may also be a paper or a similar material sheet that is suitable to be peeled, in direction “A”, by hand away from the adhesive layer 14.

The PCM layer 16 is formed of a silicone foam polymer that is impregnated in some embodiments with micro-encapsulated phase change material in the form of beads, shells or granules 110, as is shown in FIGS. 3a and 3b. In other embodiments, the PCM layer can comprise a silicone foam polymer that is impregnated with a phase change material which is absorbed into an amount of porous, inorganic, finely-sized particulate solids (a so-called “bound PCM”).

In the present disclosure, silicone is used to form an inert, moisture resistant structure for containing dry particles, encapsulated beads, and the like. Silicones, also known as polymerised siloxanes (or polysiloxanes), are polymers that include any inert, synthetic compound made up of repeating units of siloxane, which is a chain of alternating silicon atoms and oxygen atoms, frequently combined with carbon and/or hydrogen. Silicones can be synthesised with a wide variety of properties and compositions. They can vary in consistency from liquid to gel to rubber to hard plastic. They are typically heat-resistant and rubber-like, and some common forms include silicone rubber, silicone resin, and silicone caulk.

In the examples of a PCM layer in the present disclosure, the phase change material (whether encapsulated by a bead or shell, or “bound” and absorbed onto a porous solid substance) is a liquid-solid phase change material, which is of the type which typically moves from being in a solid form to become either a liquid (or even a gas) form during use, for example, a hydrocarbon such as paraffin. The phase change material, in whichever form it is present, may be distributed homogeneously, or unevenly dispersed, throughout the silicone foam of the PCM layer and still achieve its functional purpose.

The PCM layer is affixed to the backing layer 12. In some examples, the PCM layer may be between 1 to 10 mm in thickness, with a typical thickness of around 2 to 4 mm being preferred. The PCM layer can be flexible so it can be rolled, bent and shaped to desired forms. The specific composition of the PCM material and its method of manufacture is further described hereinbelow.

It noted that in some examples a further insulation foam layer, such as closed cell polyethylene may be located between the backing and the PCM layer or may become the backing layer 12.

Having a PCM layer in an insulation arrangement as shown in the drawings, can provide temperature regulation, temperature buffering or other temperature control within a structure or a building when the insulation arrangement is attached onto the building walls or onto other construction components, by absorbing or releasing thermal energy. The thermal control and temperature regulating qualities of such a PCM layer can serve to reduce energy costs for both heating and cooling of buildings and other structures.

As shown in FIGS. 3a and 3b, the PCM layer 16 includes encapsulated phase change material beads, shells or granules 110 that are mixed with, and become set into, a layer of silicone foam polymer 112 to form the PCM layer 16.

As shown in detail in FIG. 3b, each bead 110 includes a bead shell 116 that encapsulates a phase change material 114. The phase change material 114 may be composed of any one of a number of known liquid-solid phase change materials, including natural and synthetic gels, waxes, oils and/or salt-hydrates, such as paraffin wax. In some forms, the phase change material 114 is selected to phase transition at a temperature of between 15° C. and 30° C., in one particular form, between a temperature of between 20° C. and 25° C., and in one specific form, at around 23° C. The bead shells 116 may be composed of rigid plastic, although it is also envisaged that the bead shells 116 could also be composed of a resilient polymer or plastic.

The foamed polymer is composed of a resilient and flexible polysiloxane polymer such as silicone, present as a silicone foam. This class of polymer used in the PCM layer is chosen for its suitable properties of flexibility and resilience. The silicone foam has favourable fire-retardant properties which is important when dealing with potentially flammable hydrocarbon phase change materials. The use of silicone foam polymer is able to deal with many of the concerns in the prior art about the use of solid-liquid phase change materials, as it can cope with known problems such as leakage, volume expansion, and/or flammability concerns associated with the use of the phase change material (whether encapsulated by a bead or shell, or absorbed (“bound”) onto a porous solid substance).

In one example, the silicone foam polymer is formed, or cast, from two-part liquid silicone base compounds (Part A and Part B) that are mixed and cold-cured to form the silicone foam. It is noted that the cold curing can assist to reduce any damage to the shells which encapsulate phase change material, and reduce any risk of inflammation of the phase change material.

The phase change material (whether in the encapsulated form, or in the particle-absorbed “bound” form) may be added to one, or preferably both, of the two-part liquid silicone base compounds prior to the two-part liquid silicone base compounds being mixed. The mixing may occur in a mould or other suitable surface (such as an aluminium mould). This allows the phase change material, (which can be in the form of near-spherical microencapsulated phase change material beads, or particles of silicon dioxide (silica) which carry absorbed phase change material therein) to become substantially evenly distributed throughout the silicone foam. A suitable two-part silicone base is produced by supplier Shenzhen Hong Ye Jie Technology Co., Ltd (Product Name HY-F663). Tables 1 and 2 below show example compositions of a suitable Part A and Part B that are mixed to form the silicone foam.

TABLE 1
Example Composition of Part A

| Component | CAS No. | EC# | In % By Weight |
|---|---|---|---|
| Vinyl silicone oil | 68038-19-2 | — | 35 |
| Fumed Silicon Dioxide | 60676-86-0 | 293-303-4 | 50 |
| Dimethyl Polysiloxane | 63148-62-9 | 203-492-7 | 14 |
| Chloroplatinic Acid | 18497-13-7 | 241-010-7 | 1 |

TABLE 2
Example composition of Part B

| Component | CAS No. | EC# | In % By Weight |
|---|---|---|---|
| Vinyl silicone oil | 68038-19-2 | — | 35 |
| Fumed Silicon Dioxide | 60676-86-0 | 293-303-4 | 50 |
| Dimethyl Polysiloxane | 63148-62-9 | 203-492-7 | 14 |
| Hydrogen-containing | 63148-57-2 | 217-496-1 | 1 |
| Silicone Oil | | | |

By way of example, microencapsulated phase change material beads are commercially available from Hangzhou Phase Change Technology Co., Ltd., of Peoples Republic of China. The diameter of the beads may be about 1-2 micron minimum and the phase change material is an organic hydrocarbon PCM (paraffin wax) having a melting temperature in the range of 20-30° C. (other temperature ranges are available for customised applications) and preferably about 23° C. The latent heat capacity is about 100-120 kJ/kg.

By way of a further example, unencapsulated phase change material in the form of a “bound” organic hydrocarbon absorbed onto silicon dioxide (silica) particles are commercially available from Rubitherm GmbH of Germany. The PX-series of powders contain phase change material absorbed into a porous support structure of hydrophilic silica powder. The bound PCM is always present as a dry powder solid in its initial form, but the PCM can melt and congeal for storing or releasing latent heat associated with the phase change. The phase change material is an organic hydrocarbon representing about 60% of the weight of the product having a melting temperature in the range of 22-25° C., however it can be used up to about 55° C. The latent heat capacity is about 95-100 kJ/kg. Because the PX-series product is sold in free-flowing silica powder form, into which the PCM is rigidly bound, it is easier to use and transport compared with microencapsulated PCM beads, which are susceptible to being crushed or damaged, resulting in potential leakage of phase change material.

The ratio, by bulk volume, of the phase change material (in encapsulated bead form, or in the bound form absorbed onto inorganic solids) to the two-part liquid silicone bases may preferably be about 1:3 (being 1 part solids carrying the PCM, to 3 parts liquid silicone bases). It is noted that this ratio may be varied between about 1:2 and 1:4. However, at a ratio of 1:2, the additional beads or inorganic solids may interfere with the curing of the foam polymer and become unevenly distributed, and at a ratio of 1:4, the lower amount of solids carrying the PCM may produce a product PCM layer of insufficient thermal capacity once it is formed.

Curing times typically required for silicone foam polymer using either type of solids carrying the PCM are fast, at around 3-6 minutes. The use of such fine particle size solids carrying the PCM also means that a sufficiently thin PCM layer can be formed, (the layer of between 1 to 10 mm in thickness, with a typical thickness of around 2 to 4 mm being preferred), a thickness which would be difficult to achieve with any structural integrity and flexibility if use was made of macroencapsulated particles carrying phase change material, or if large size particles were used for carrying bound phase change material (for example, of the order of 0.5 mm up to 2 mm).

The fast curing time, and additionally the generally viscous nature of the silicone foam polymer (once the silicone bases are mixed together), also means that there is a sufficient suspension of the fine particles during the curing process to avoid segregation and a non-homogeneous distribution of the microbeads or solids carrying the phase change material in the final formed PCM layer.

Methods to produce the insulation material including the PCM layer may vary from manual mixing through to the use of continuous throughput, industrial-scale machines. Manual mixing may include firstly introducing the microencapsulated phase change material beads, or inorganic particles carrying absorbed phase change material, into the two-part liquid silicone bases, and then mixing the two part liquid silicone bases together, prior to pouring the mixture onto a suitable backing layer that may be fitted to a mould. The PCM layer is then allowed to cold cure prior to the adhesive layer being applied such as by spraying a pressure sensitive adhesive onto the cured PCM layer. The removable cover layer may then be fitted to cover the pressure sensitive adhesive.

One example envisaged of such an industrial-scale machine includes each of the two-part liquid silicone bases being individually premixed with microencapsulated phase change material beads, or inorganic particles carrying absorbed phase change material. Then the resulting two-part liquid silicone bases are each pumped separately to a manifold having two spray nozzles. Each of the two-part liquid silicone bases are spray ejected from the nozzles to form jets of solid-fluid mixture which cross-over one another, causing the two flows to become mixed together after which the resulting uncured silicone foam polymer mixture falls downward onto a supporting or backing layer such as paper or the like. The silicone foam polymer then cold cures, preferably with some ventilation assistance, and thereafter the adhesive layer may be applied, followed by the application of the removable cover layer. The silicone foam polymer layer is arranged to be substantially flat and coextensive on the backing layer. The insulation material may be formed in lengths that are rolled prior to being stored and/or transported, for example, in a 1200 mm width strip and having a length of 20 metres.

Various uses for the insulation material arrangement 10 are shown in FIGS. 4a to 4c, which illustrate a method of applying the insulation material 10 to a building structure or material 50, such as a wall or roof surface 52. The method includes the step of urging the pressure sensitive adhesive layer 14 of the material arrangement 10 against the surface of the building structure such that the PCM layer 16 of the material arrangement 10 is bonded to the surface, so that the backing layer 12 which supports the PCM layer 16 is facing away from the surface 52. In examples wherein the insulation material 10 also includes a cover layer 10, the method also includes the prior step of removing the cover layer 18 from the adhesive layer 14, as shown in FIG. 4a, prior to the adhesive layer 14 being bonded to the surface 52 of the building structure or material 50.

It is noted in this example that the wall or roof surface 52 may be plasterboard and the insulation material 10 may be affixed thereto, in-situ, prior to the plasterboard being secured to the wall studs. The insulation material 10 may be fitted, in-situ, to the plasterboard prior to the plaster board being secured to wall studs as shown in FIG. 4b. These method steps can also be applied to building products which are not already erected in place as part of a building structure, but are being produced in a remote location for later movement to, and assembly at, a construction site. The types of walls may include brick veneer walls or cladded walls, for example walls which include metal cladding instead of bricks. However, the material arrangement 10 may be applied to any suitable surface to increase its thermal insulation properties.

The insulation material arrangement 10 including a PCM layer comprising a fire-retardant silicone foam polymer material which is impregnated with phase change material, has several advantageous features:
a. The material arrangement 10 described herein is self-adhesive and flexible, allowing the material arrangement to be affixed, in-situ by the use of hand pressure, to any suitable surface, such as a wall of the building structure, or to another building product or material;
b. The PCM layer of silicone foam polymer impregnated with distributed microencapsulated phase change material beads, or inorganic particles carrying absorbed phase change material, enables the material arrangement to significantly improve the thermal insulation properties of the wall surface, or of the building product to which it is fitted;
c. Moreover, the use of silicone foam polymer provides fire-retardant properties to further enhance the fire-resistance or flame-retardant nature of a building structure, and to deal with the safety concerns when dealing with liquid-solid phase change materials which comprise flammable substances.
d. The material arrangement may also be used an underfloor layer or lining as the silicone foam polymer has resilient properties providing good rebound.

The use of two-part, cold cured, liquid silicone bases also enables the pre-mixing of the microencapsulated phase change material beads, or inorganic particles carrying absorbed phase change material, within those liquid silicone bases. Doing this assists with the even and uniform distribution of the phase change material particles in the resulting silicone foam polymer, which has a sufficiently high viscosity to suspend the phase change particles throughout the cure time. The cold curing of the mixture assists in inhibiting damage to the microencapsulated phase change material beads. The rapid curing and formation of a thin and flexible PCM layer formed with silicone foam polymer also allows for scale-up of the manufacturing process to a continuous basis, including the subsequent step of rapid application of the pressure sensitive adhesive to the substantially cured PCM layer.

Silicones exhibit many useful characteristics which make them applicable to building insulation applications, where this substance comes into close contact with builders and dwellers, including:
a. low thermal conductivity;
b. low chemical reactivity;
c. low toxicity;
d. thermal stability (constancy of properties over a wide temperature range of −100 to 250° C.);
e. the ability to repel water and form watertight seals; and
f. resistance to oxygen, ozone, and ultraviolet (UV) light.

In addition to these properties, the inventors decided to use a silicone foam polymer substrate because of:
a. its fire-retardant properties (low flammability UL94 V-0);
b. its flexibility, due to its ability to be thinly cast (as little as 1-10 mm, particularly 2-4 mm thickness;
c. the lightweight nature of the resultant foam polymer; and
d. its incompressibility when cured (has a high compression rating when compared to plastic-based foams).

Finally, silicone foam polymers were found to be most compatible for use with the selected phase change materials of microencapsulated phase change material beads, or inorganic particles carrying absorbed (“bound”) phase change material. As already noted, there were concerns in the prior art about the use of solid-liquid phase change materials, insofar as finding a way to cope with leakage, volume expansion, and/or flammability, particularly when dealing with encapsulated phase change materials. When microencapsulated phase change materials are used, and the silicone foam was pierced (for example by nails, screws etc during wall drilling) there was a risk that the PCM could leak from its encapsulated coating, and form a residue on the finished foam. This would expose hydrocarbon-based phase change materials and a potential combustion hazard would be created.

The use of bound phase change materials (such as the Rubitherm PX product range) eliminates this problem, as the piercing of the silicone foam polymer layer, or even cutting across an entire cross-section of the insulation material product, will not disturb the integrity of the phase change material, which remains within the inorganic binding medium (such as silicon dioxide (silica)), and does not leak out.

In addition, it was found that phase change materials which were chemically bound using a silica substrate medium were more readily compatible with silicone foam during the formation and curing process, when compared with other types of phase change materials, for example the plastic shell exterior of encapsulated PCMs. Again, this factor supports the curing of a very thin PCM layer sheet, typically 2 mm-8 mm, and even as thin as 2 mm to 4 mm, but which still has good structural integrity.

Advantageously also, it is noted that the cost of Rubitherm PX series silica-bound phase change material is approximately half the cost of microencapsulated phase change material of a comparable particle size range. Even though the latent heat capacity of the Rubitherm PX product is a little lower than the equivalent microencapsulated PCM product (on an equivalent mass basis), because of the cost savings achieved using this product, a greater amount of the bound PCM can be added into the silicone polymer foam per unit volume (without affecting its ability to cure), which ultimately creates a more cost-effective end use insulation product for the end user.

The use of silicone foam polymer is an ideal way to incorporate microencapsulated phase change material beads, or inorganic particles carrying absorbed phase change material, to form a layer as a part of building materials such as wallboard. The poor bonding nature of the PCM particles and beads means that direct incorporation of such substances into wallboards, gyprock and the like is not particularly effective or feasible. In addition, doing so does not provide a means of dealing with the risk of combustion of organic phase change materials, unless a separate, suitable fire-retardant substance is also added into the material composition of the building product, which ultimately necessitates a more complex and costly manufacturing process, which is therefore undesirable.

The use of a fire-retardant silicone foam polymer creates a protective substrate to for flammable organic phase change materials. The finished product layer has a recommended constant temperature use range of −55 C to 200 C. Plastic based foams would be destroyed at the higher end of these temperatures. If the substrate is destroyed, the phase change material can be released and cause a fire hazard.

In the foregoing description of certain embodiments, specific terminology has been resorted to for the sake of clarity. However, the disclosure is not intended to be limited to the specific terms so selected, and it is to be understood that each specific term includes other technical equivalents which operate in a similar manner to accomplish a similar technical purpose. Terms such as “left” and right”, “front” and “rear”, “above” and “below” and the like are used as words of convenience to provide reference points and are not to be construed as limiting terms.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any known matter or any prior publication is not, and should not be taken to be, an acknowledgment or admission or suggestion that the known matter or prior art publication forms part of the common general knowledge in the field to which this specification relates.

Furthermore, invention(s) have described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g., aspects of one embodiment may be combined with aspects of another embodiment to realise yet other embodiments. Further, each independent feature or component of any given assembly may constitute an additional embodiment.

1. A material arrangement for insulating a building structure, the material arrangement including:
a backing layer;
an adhesive layer including a pressure sensitive adhesive; and
a phase change material layer between the backing layer and the adhesive layer;
wherein the phase change material layer includes a fire-retardant silicone foam polymer material which is impregnated with phase change material, said layer being formed by mixing the phase change material with uncured silicone foam polymer then cold-curing;
and the adhesive layer is adapted to secure the material arrangement to the structure in a fitted condition in which the adhesive layer is contacted with the building structure.

2. The material arrangement according to claim 1, wherein the material arrangement further includes a removable layer arranged to cover the adhesive layer in an initial covered condition and expose the adhesive layer in a removed condition.

3. The material arrangement according to claim 2, wherein at least one of the backing layer and removable layer is paper.

4. The material arrangement according to claim 1, wherein the material arrangement is flexible so as to be formable into a roll.

5. The material arrangement according to claim 1, wherein the phase change material layer includes a liquid-solid phase change material.

6. The material arrangement according to claim 1, wherein the phase change material layer includes an encapsulated phase change material.

7. The material arrangement according to claim 6, wherein the encapsulated phase change material is a micro-encapsulated phase change material provided in the form of a least one of beads and granules.

8. (canceled)

9. The material arrangement according to claim 1, wherein the phase change material layer includes a phase change material bound or absorbed into a porous support structure.

10. (canceled)

11. The material arrangement according to claim 9, wherein the porous support structure is an inorganic particulate material.

12. (canceled)

13. The material arrangement according to claim 1, wherein the silicone foam polymer material is a polysiloxane polymer.

14. (canceled)

15. The material arrangement according to claim 1, wherein the backing layer may be at least one of paper, polymeric film, foil, nonwoven or high thread count woven cloth, and wherein the adhesive layer includes an acrylic, rubber or silicone adapted to be tacky at ambient temperature.

16. A self-adhering material arrangement including a flexible phase change material layer and a pressure sensitive adhesive layer applied to a face of the phase change material layer, wherein the phase change material layer includes a fire-retardant silicone foam polymer material impregnated with phase change material, said layer being formed by mixing the phase change material with uncured silicone foam polymer then cold-curing, and wherein the adhesive layer is adapted to adhere the phase change material layer to a supporting surface in a fitted condition in which the adhesive layer is urged against the supporting surface.

17. The self-adhering material arrangement according to claim 16, wherein the phase change material layer includes a liquid-solid phase change material.

18. (canceled)

19. A method of forming a self-adhering material arrangement, the method including the steps of:
forming a flexible phase change material layer by mixing and cold-curing, the layer being supported by a backing, wherein the phase change material layer includes a fire-retardant silicone foam polymer material impregnated with phase change material; and
applying a pressure sensitive adhesive layer to a face of the phase change material layer, the adhesive layer being adapted to secure the material arrangement to a building structure or material in a fitted condition in which the adhesive layer is pressed against the structure or material.

20. The method according to claim 19, wherein the steps for forming the flexible phase change material layer further include:
providing, a liquid mixture that is cold curable to provide the flexible silicone foam polymer;
introducing, a phase change material into the liquid mixture so that it is substantially dispersed throughout; and
curing, the liquid mixture so as to form the flexible phase change material layer upon which the adhesive layer is applied.

21. The method according to claim 19, wherein the phase change material layer includes a liquid-solid phase change material.

22. (canceled)

23. A method of applying an insulation material to a building structure, the method including the steps of:
urging a pressure sensitive adhesive layer of a material arrangement against a surface of the building structure such that a phase change material layer of the material arrangement is bonded to the surface, wherein the phase change material layer includes a fire-retardant silicone foam polymer material impregnated with phase change material, said layer being formed by mixing the phase change material with uncured silicone foam polymer then cold-curing, and a backing layer that supports the phase change material layer is facing away from the surface.

24. The method according to claim 23, wherein the method further includes:
removing a cover layer from the adhesive layer.

25-26. (canceled)

27. A material arrangement for insulating a building product, the material arrangement including:
a backing layer;
an adhesive layer including a pressure sensitive adhesive; and
a phase change material layer between the backing layer and the adhesive layer;
wherein the phase change material layer includes a fire-retardant silicone foam polymer material which is impregnated with phase change material, said layer being formed by mixing the phase change material with uncured silicone foam polymer then cold-curing; and
the adhesive layer is adapted to secure the material arrangement to the building product in a fitted condition in which the adhesive layer is contacted with the building product.

28. The material arrangement according to claim 27, wherein the phase change material layer includes a liquid-solid phase change material.

29. (canceled)

30. The material arrangement according to claim 27, wherein the phase change material layer includes a phase change material which is bound or absorbed into a porous support structure.

31. The material arrangement according to claim 27, wherein the silicone foam polymer material is a polysiloxane polymer.

32. The self-adhering material arrangement according to claim 16, wherein the phase change material layer includes a phase change material which is bound or absorbed into a porous support structure.

33. The self-adhering material arrangement according to claim 16, wherein the silicone foam polymer material is a polysiloxane polymer.

34. The method according to claim 19, wherein the phase change material layer includes a phase change material which is bound or absorbed into a porous support structure.

35. The method according to claim 19, wherein the silicone foam polymer material is a polysiloxane polymer.
